(19) United States
(12) Patent Application Publication
(10) Pub. No.: US 2009/0325133 A1
(43) Pub. Date: Dec. 31, 2009

(54) Educational Aid for Teaching a Sequence

(76) Inventor: Lecia Aaron Guill, Cleveland, TN (US)

Correspondence Address: KNOX PATENTS, P.O. BOX 30034, KNOXVILLE, TN, 37930-0034, US

(21) Appl. No.: 12/146,794

(22) Filed: Jun. 26, 2008

(51) Int. Cl. G09B 19/22

(52) U.S. Cl. 434/128

(57) ABSTRACT

An educational aid is provided for teaching a sequence, including groups and subgroups within the sequence, to a student. In one embodiment, the educational aid is a set of mats. The mats bear information about the sequence, such as the sequence members and the groups and subgroups within the sequence. The mats are arranged in sequential order to form a navigable path. The path is repeatedly traversed by the student. As the student becomes knowledgeable about the sequence, the path is arranged such that traversal is more difficult. The path includes test points for evaluating the student's knowledge of the sequence. The changeable path and varying test points make the path incrementally more or less complex or equally complex at each progression through the teaching process. A competitive game is presented in which two or more students compete to complete increasingly complex paths.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to an educational aid. More particularly, this invention pertains to an educational aid for teaching a sequence to a student.

2. Description of the Related Art

Often students must learn a sequence. A sequence is a set of named objects arranged in a serial order. For example, the books of the Holy Bible are learned in the order in which they appear. The days of the week and months of the year are also learned in a specific sequence. Many sequences can be divided into groups. The Holy Bible, for instance, is divisible into the Old and New Testaments. Within those groups, smaller subgroups are often identified, such as The Law and The Gospels. Other groupings that are taught in a sequence are the elements of the periodic table. Although each element has a unique atomic number, the elements are also grouped into metals and nonmetals which are further subgrouped into alkali metals, transition elements, noble gases, and other categories.

There are educational aids for teaching sequences in the prior art, however, these aids fail to provide the student with an adequate opportunity to learn groups within the sequence being taught. While some color variations are used to identify a given group, the educational aids in the prior art do not take a meaningful approach to teaching both groups and subgroups within a sequence.

Learning a sequence can be a daunting task, especially for young people. Because games and simulations are fun, teachers have sought to use them as an effective way to foster learning. Active and participatory learning activities, such as games and simulations, can provide much needed motivation to students.

Proper testing of the student will also provide motivation to learn. Tests can help motivate students as well as discourage them. Motivational testing occurs when the difficulty level allows the student a high level of success. When the educational aid allows for increasing the difficulty as the student progresses, the student is more likely to become directly involved in the learning process.

Educational aids for teaching sequences often require students to memorize a sequence in a fixed environment, such as in a list or as part of a puzzle. The fixed sequence of the prior art fails to provide the student with increasingly difficult challenges during the learning process. For example, U.S. Pat. No. 5,074,794, titled “Sequencing Puzzle,” issued to Von Hagen on Dec. 24, 1991, discloses a puzzle for teaching the sequence of an ordered series of members where the first member in the series must be placed on the puzzle before the second member, the second must be in position before the third, and so forth.

U.S. Pat. No. 5,997,304, titled “Interactive phonics learning mat,” issued to Wood on Dec. 7, 1999, discloses a learning mat with touch-sensitive keys and corresponding indicia indicating letters or numbers. When the keys are pressed, the letter or number is audibly identified. The mat lies on the floor and the keys are activated by the foot.

The prior art educational aids do not adequately provide the student with active and participatory learning activities. They also fail to test the student's learning. Such failings in educational aids miss valuable opportunities to motivate the student to learn sequences.

There needs to be an educational aid for teaching sequences that requires active participation by the student. There also needs to be an educational aid for teaching sequences that progressively increases in difficulty as the student becomes more familiar with the sequence.

### BRIEF SUMMARY OF THE INVENTION

In accordance with one embodiment of the invention, teaching a sequence to a student in a way that challenges the student's knowledge of the sequence as the student's knowledge of the sequence increases while maintaining the student's attention is accomplished by presenting the sequence to the student as a navigable path that is changeable such that traversal of the path is made increasingly difficult as the student's knowledge of the sequence increases. In this way, the student participates in the learning activity by traversing the path. The student is challenged by the path because it is changeable. The path is made increasingly difficult as the student becomes familiar with, or gains more knowledge of, the sequence. In this way, the student's interest is maintained.

In one such embodiment, the educational aid is a collection of mats, or carriers, bearing sequence indicia. The mats are placed on a training surface to form a path and the student traverses, or navigates, the mats. The sequence is represented on the path by the sequence indicia on the mats. The student repetitively traverses the path by moving from one mat to another according to the sequence. The series of mats is configured to present paths progressively more complex, such as by changing the configuration of the path, and/or adding baffles. In one embodiment, the educational aid is provided in a kit containing a collection of mats and an instruction sheet illustrating the use of the mats as an educational tool.

In accordance with another embodiment of the invention, maintaining a student's interest and/or attention is accomplished by playing a competitive game that involves navigating a path representing a sequence. In this way, the student participates by competing with other students where knowledge of the sequence being taught is demonstrated.

In one such embodiment, a competitive game is played on a navigable path made up of mats representing a sequence. Two or more students compete to successfully traverse the path. Each time that more than one student successfully traverses the path, the path is made more complex such that traversal of the path is progressively more difficult. The winner is the student who successfully traverses the path that no other student successfully traverses.

In accordance with yet another embodiment of the invention, allowing for physical activity while teaching a sequence to a student is accomplished by causing the student to physically traverse a navigable path representing a sequence. In one such embodiment, the mats are arranged on a training surface such that the student physically moves from one mat to another. For example, the educational aid is a collection of mats configured for standing upon. The mats, which bear sequence indicia, are arranged on the floor in sequential order. The student walks over the mats in sequential order according to the indicia on the mats.

Where the student has a physical disability, the navigable path is presented such that it accommodates the needs of the student. In one such embodiment, where the student is blind, the mats are marked with braille indicia. The mats are configured such that they temporarily attach to a training surface to allow the path configuration to be readily changed. The physical activity, in this case, is the act of traversing the path by moving a hand along the path from one mat to the next according to the sequence.

In accordance with still yet another embodiment, the sequence being taught includes a group. A group is a subset of the sequence where the subset members are identified by some common trait of the members. In one such embodiment, a group within the sequence is identified by a difference in one or more characteristics of the mat. Examples of such characteristics include shape, indicia, color, texture, font, and size. In another embodiment, a group is identified by a mat bearing a group name.

In accordance with even still yet another embodiment of the invention, testing a student's knowledge of a sequence where a navigable path that is changeable is presented is accomplished by changing the path such that not all of the sequence is represented and requiring the student to identify the missing members of the sequence as the student traverses the path.

According to one such embodiment, a student's knowledge of a sequence is tested by adding test points to the series of mats arranged in a navigable path defining the sequence. The test points inserted into the path replace either one or more members, a group, or a subgroup of a sequence. That is, the test point is a gap in the sequence of named objects. The student, upon reaching a test point, is to provide a response in which the missing sequence information is provided.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a symbolic view of one embodiment of an educational aid being traversed by a student;

FIG. 2 is a plan view of the educational aid in FIG. 1 arranged into a navigable path with a complex configuration;

FIG. 3 is a plan view of the educational aid in FIG. 1 arranged into another navigable path with a very complex configuration;

FIG. 4 is a plan view of the path segment in FIG. 3 with a test point;

FIG. 5 is a side view of one embodiment of a mat;

FIG. 6 is a side view of another embodiment of a mat;

FIG. 7 is a flow diagram of one embodiment of a teaching method using an educational aid to teach a sequence to a student; and

FIG. 8 is a flow diagram of one embodiment of a competitive game using an educational aid to teach a sequence to a student.

### DETAILED DESCRIPTION OF THE INVENTION

An apparatus and method for teaching a sequence to a student is disclosed. The apparatus is an educational aid 100 that enables a student 102 to learn a sequence. The method includes repetitively using the apparatus to teach a sequence.

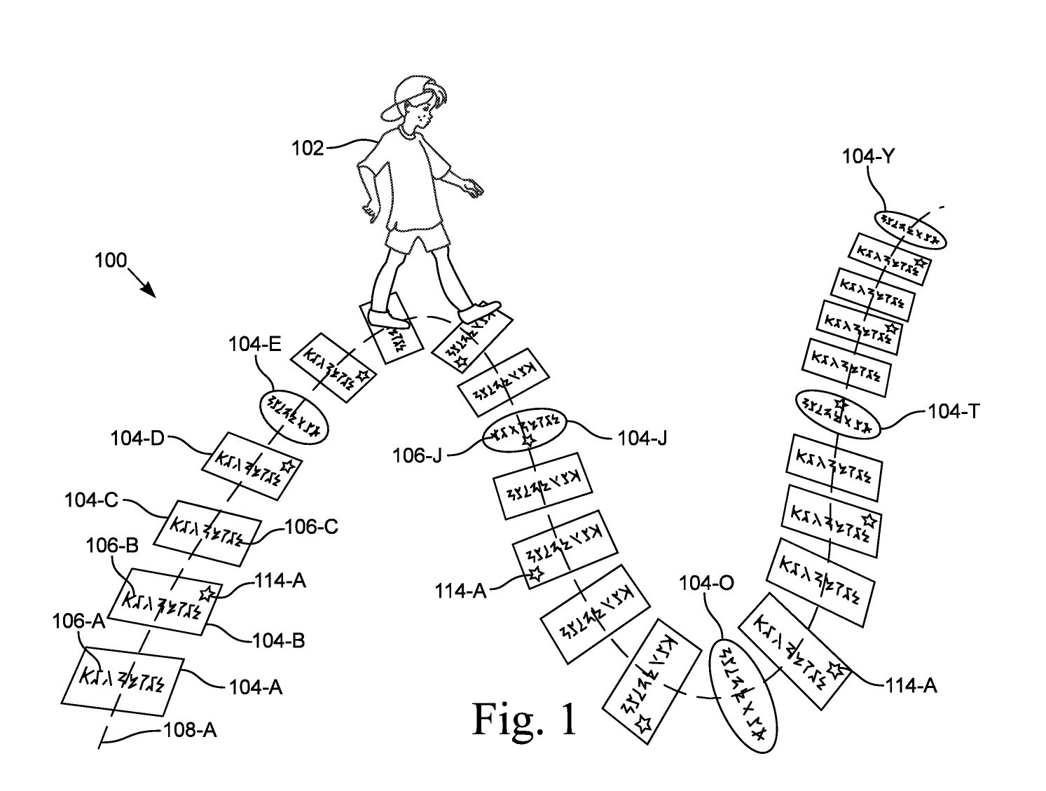

FIG. 1 illustrates a symbolic view of one embodiment of an educational aid 100 being traversed by a student 102. The educational aid 100 is a collection of mats 104-A to 104-Y bearing sequence indicia 106 and/or group indicia 114. The educational aid 100 is arranged such that the mats 104 are in a sequential order. The arrangement of the mats 104 in a sequential order forms a path 108. The path 108 includes mats 104 that bear sequence indicia 106 representing members of the sequence and/or group indicia 114 representing members of a group or the group names within the sequence. In one embodiment, the educational aid 100 is provided in a kit containing a collection of mats 100 accompanied by an instruction sheet illustrating the use of the mats 104 as an educational tool.

In the illustrated embodiment, the mats 104 are arranged to form a simple path 108-A, which is illustrated with a dashed line in the figure. The path 108-A is defined by an entrance mat 104-A and an exit mat 104-Y. The path 108-A has a direction that runs from the entrance mat 104-A and to the exit mat 104-Y. Often there are other possible routes that can be taken for a given arrangement of the educational aid 100, but only the path 108 is the route that correctly follows the sequence being taught.

The path 108-A, shown in the figure, is simple because the mats 104 are arranged into a path 108-A where no prior knowledge of the sequence is necessary in order to traverse the path 108-A. As the student 102 traverses the path 108-A, the second, or next, mat 104-B in the sequence is apparent by its location relative to the first, or current, mat 104-A. That is, the path 108-A has a straight or curving configuration that does not present any route to the student 102 other than the path 108-A from the entrance mat 104-A to the exit mat 104-Y.

In the illustrated embodiment, the mats 104 are arranged on a training surface, such as a floor, and the student 102 walks on the mats 104. In this way, the student 102 is physically active while learning the sequence. Physical activity is achieved when the path 108 is presented in a way that the student 102 walks, hops, runs, or otherwise physically exerts himself while traversing the path 108.

In other embodiments, the mats 104 are arranged on a training surface, such as a table, wall, and/or ceiling, and the student 102 traverses the path 108 by progressing from one mat 104 to the next, for example, by pointing or touching the mat 104 with a hand, a pointer, or another object. In one such embodiment, the sequence indicia 106 and/or group indicia 114 are tactile indicators. In this way, a blind student 102 follows the path 108 by reading indicia 106, 114 written in braille.

The student 102 traverses the path 108-A to learn a sequence. A sequence is a series of named objects that are arranged in a specified order, or sequential order, such as alphabetical or chronological. For example, one sequence is the names of the Presidents of the United States arranged in the order in which they held their offices. Examples of other sequences include the elements of the periodic table arranged in the order of their atomic weight, the states of the United States of America arranged in the order in which they joined the union, and the books of the Holy Bible arranged in the order in which they appear in the Holy Bible.

The sequence is represented on the path 108-A by the sequence indicia 106 on the mats 104. In FIG. 1, the educational aid 100 is used to teach a sequence, for example, the numbers starting at one and increasing by one for each mat 104 on the path 108-A. The first mat 104-A bears the sequence indicia 106-A representing the number one. The second mat 104-B bears the sequence indicia 106-B representing the number two. In like manner, the sequence indicia 106 on the mats 104 represent increasing numbers in the direction of the path 108-A from the second mat 104-B to the exit mat 104-Y. Accordingly, the student 102 traverses the path 108-A starting at the first mat 104-A, moving to the second mat 104-B, then to the third mat 104-C, and so on until the student 102 moves to the exit mat 104-Y, or last mat 104. In one embodiment, a teacher, or instructor, recites the members of the sequence as the student 102 approaches each mat 104. In such an embodiment, the teacher is providing guidance to the student 102, thereby helping the student 102 recognize and learn the members of the sequence as the path 108-A is traversed.

The length of the path 108-A varies, in part, by the number and arrangement of the members of the sequence to be taught. In various embodiments, the sequence to be taught is any number of members of a sequence up to the number of members in the full sequence. For example, in one embodiment, a path 108 includes, for the sequence of Presidents of the United States ordered by when they held office, the Presidents that served in the 20th Century. The number of mats 104 used to form the path 108-A is determined by the number of items in the sequence to be taught.

The length of the path 108-A also varies by the size of the mats 104. The size of the mats 104 depends on the use of the mats 104, such as the age and/or size of the student 102 and the manner in which the sequence is presented on the mats 104. For example, where the student 102 is a small child and the mats 104 are separated by a distance approximating a single step of the child, the mats 104 are small so that the child is able to take the steps. Also, in one embodiment, where several members of a sequence are represented on a single mat 104, the mat 104 is larger than where fewer members of the sequence are represented.

Proper knowledge of a sequence sometimes requires that the student 102 know the groups within a sequence. It is often insufficient that a student 102 know the elements of the periodic table by their atomic weight. A student 102 should also know the classifications of the elements as metals and non-metals and so forth for effective knowledge of the periodic table.

In the illustrated embodiment, the sequence is divided into groups. A group is a subset of the sequence where the subset members are identified by a common characteristic of the members. For example, one group represented in the path 108-A is the subset of numbers that are divisible by the number five, that is, the numbers five, ten, fifteen, etcetera. The group is represented by the mats 104-E, 104-J, 104-O, 104-T, and 104-Y positioned as every fifth mat 104 in the path 108-A. The group is represented by mats 104 having an oval shape, as compared to the rectangular shape of the mats 104-A, 104-B, 104-C, 104-D that are not members of the group. The shape of a mat 104 is one characteristic that represents a group.

A sequence does not always include a group, nor is it limited to a single group. For example, another group represented in the path 108-A is the subset of numbers that are even. The members of the group of even numbers are represented by the group indicia 114-A. Where there is one group identified within a sequence, the members of the sequence that are not identified as members of the one group are members of another group. That group being those members of the sequence that are not members of the one group. For example, the group of odd numbers in the path 108-A are represented by the lack of group indicia 114-A.

The mat 104-B, which bears the sequence indicia 106-B representing the even number two, also bears the group indicia 114-A. A single member of the sequence may also belong to another group within the same sequence. For example, the mat 104-J having the oval shape of a member of the group of numbers divisible by five also bears the group indicia 114-A representing those members of the sequence that are even. The mat 104-J bears the sequence indicia 106-J representing the number ten, which is both divisible by five and an even number.

Additionally, it is possible for a group to be divided into other groups, or subgroups. In various embodiments, groups and subgroups are indicated by the mats 104 representing a group having some characteristic being different than that of mats 104 representing non-group members. Examples of mat 104 characteristics include shape, color, texture, and/or size. Alternatively, the mats 104 bear sequence indicia 106 and/or group indicia 114. The indicia 106, 114 have characteristics that are also varied to represent different groups. Examples of indicia 106, 114 characteristics include color, texture, shape, and/or font.

In the illustrated embodiment, the mats 104 include oval and rectangular shapes, as well as group indicia 114. These variations are shown for illustration purposes and are not intended to require the existence of shape variations or group indicia 114 during use of the educational aid 100. The student 102 having no knowledge of the sequence will benefit from a simple path 108 made up of mats 104 having all the same shape with only sequence indicia 106 presented on the mats 104.

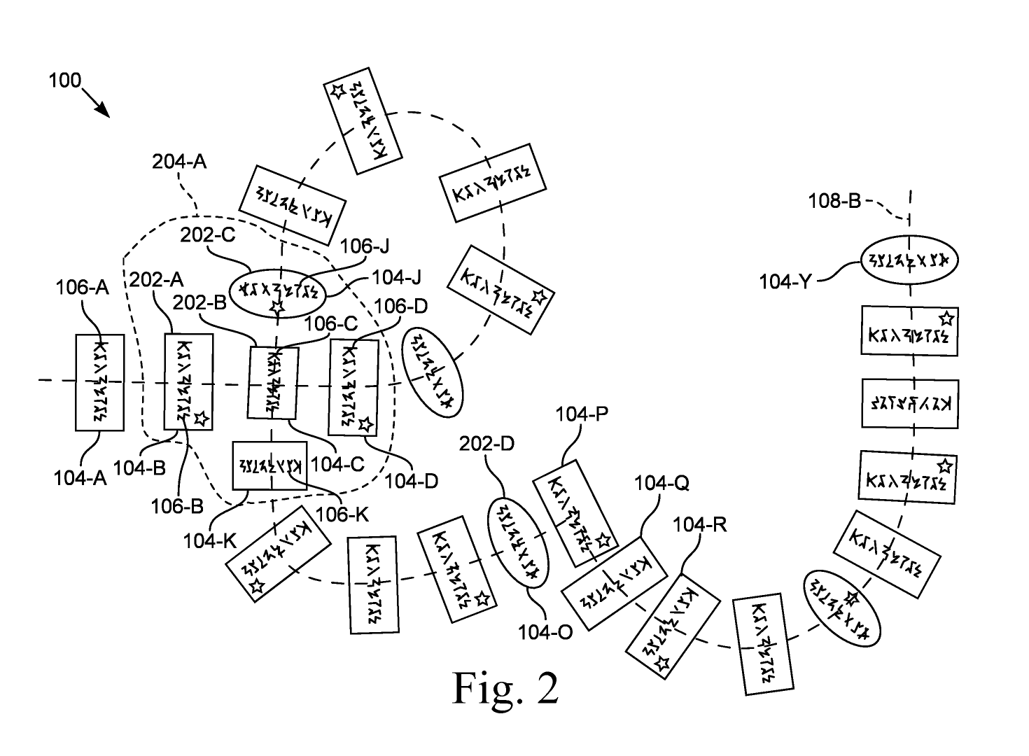

FIG. 2 illustrates a plan view of the educational aid 100 in FIG. 1 arranged into a navigable path 108-B with a complex configuration. The complexity of the path 108-B arises from baffles 202-A, 202-B, 202-C, 202-D. A baffle 202 is a mat 104 located such that adjacent to the baffle 202 are more than two other mats 104. For example, four mats 104-B, 104-D, 104-J, 104-K are adjacent the baffle 202-B. A baffle 202 is located in such a way that the next mat 104 in the sequence is not apparent by its location relative to the baffle 202, that is, there are at least two mats 104 to select from, only one of which is the next mat 104 in the path 108. The next mat 104 is the one with sequence indicia 106 indicating the next member of the sequence. Where the educational aid 100 is arranged such that there is more than one route, such as an arrangement including a baffle 202, the path 108 presents the members of the sequence being taught in sequential order.

The complexity introduced to a path 108 by a baffle 202 is based on the number of mats 104 located within reach of the student 102. The reach of the student 102 is defined by a teacher or otherwise determined prior to traversal of the path 108. A path 108 is also made more complex as the number of baffles 202 on the path 108 increases. For example, a path 108 having three baffles 202 is more complex than a path 108 having only two baffles 202. As a path 108 is made more complex, successful traversal of the path 108 requires more knowledge of the sequence being taught.

The path 108-A shown in FIG. 1 is reconfigured into path 108-B, which includes several baffles 202-A, 202-B, 202-C, 202-D such that the path 108-B is more complex than path 108-A. For a student 102 to successfully traverse the path 108-B, the student 102 must consider more than one route. For example, the mat 104-B is a baffle 202-A where four mats 104-C, 104-D, 104-J, 104-K are within the reach of the student 102. Each mat 104-C, 104-D, 104-J, 104-K presents a different route that may be taken.

When the student 102 reaches the baffle 202-A, the student 102 must make a decision as to which one of four mats 104-C, 104-D, 104-J, 104-K is next in the path 108-B. While there are three possible directions for the student 102 to go, left, right, or straight, there are two mats 104-C and 104-D that are straight ahead. For the mat 104-D to be correct, the student must pass over the mat 104-C. The mats 104-B, 104-C, 104-D, 104-J, 104-K make up an intersection 204-A. That is, the mats 104-B, 104-C, 104-D, 104-J, 104-K are arranged in such a way that there is a single mat 104-C that joins the other mats 104-B, 104-D, 104-J, 104-K together. Whenever there is an intersection 204, there will be a possible route that skips over the centrally located mat 104. Although such a route exists, the path 108 does not necessarily follow that route.

The task for the student 102 is to rely on the sequence indicia 106-B, 106-C, 106-D, 106-J, 106-K located on the mats 104-B, 104-C, 104-D, 104-J, 104-K to traverse the path 108-B. The student 102 having a knowledge of the sequence makes the decision based on the current mat 104-B bearing sequence indicia 106-B. The knowledgeable student 102 will recognize that the next member of the sequence is represented by the sequence indicia 106-C on the mat 104-C and will proceed down the path 108-B.

The student 102 next encounters the mat 104-C. The mat 104-C is also a baffle 202-B. The decision, upon reaching the baffle 202-B, is which one of the three mats 104-D, 104-J, 104-K bears the sequence indicia 106-D representing the next member of the sequence. Again, there is a mat 104-D located directly in front of the baffle 202-B. In the illustrated embodiment, the student 102 who follows the path 108-B will move to the mat 104-D located directly in front of the baffle 202-B.

While the above discussion is based on mats 104 bearing sequence indicia 106, it is also possible for the mats 104 to bear group indicia 114. In one embodiment, the group indicia 114 is presented in combination with the sequence indicia 106 to identify a member of a group. In another embodiment, the group indicia 114 identifies the name of a group of members within the sequence.

The path 108-B curves around from the mat 104-D to the mat 104-J. Complexity of the path 108-B varies based on the number of mats 104 on the curve between 104-D and 104-J. Where there are only a few mats 104, the mats 104 are closer together such that a baffle 202 may arise. Where there are many mats 104, the student 102 may not recall which mats 104 have already been traversed.

The mat 104-J is also a baffle 202-C. The student 102 must make a decision as to which one of the four mats 104-B, 104-C, 104-D, 104-K is the next mat 104 in the path 108-B. The baffles 202-A and 202-C present the same number of possible mats 104 to choose from, however, three of the mats 104-B, 104-C, 104-D presented at the baffle 202-C have already been traversed. It is clear to the wary student 102 that the path 108-B skips over the mat 104-C to the mat 104-K.

The student 102 then encounters the mat 104-O. The mat 104-O is a baffle 202-D in the case where the reach of the student 102 provides for skipping over an adjacent mat 104. The baffle 202-D presents a choice of moving to a mat 104-P or a mat 104-Q. If the student 102 moves to the mat 104-Q, the student 102 would then move back to the mat 104-P, and then skip over the mat 104-Q to the mat 104-R. The baffle 202-D is less complex than the baffles 202-A and 202-B because there are fewer mats 104 to select from. Even though the baffle 202-C presents more mats 104 initially, the baffle 202-C is less complex because it only presents one mat 104-K that has not yet been traversed.

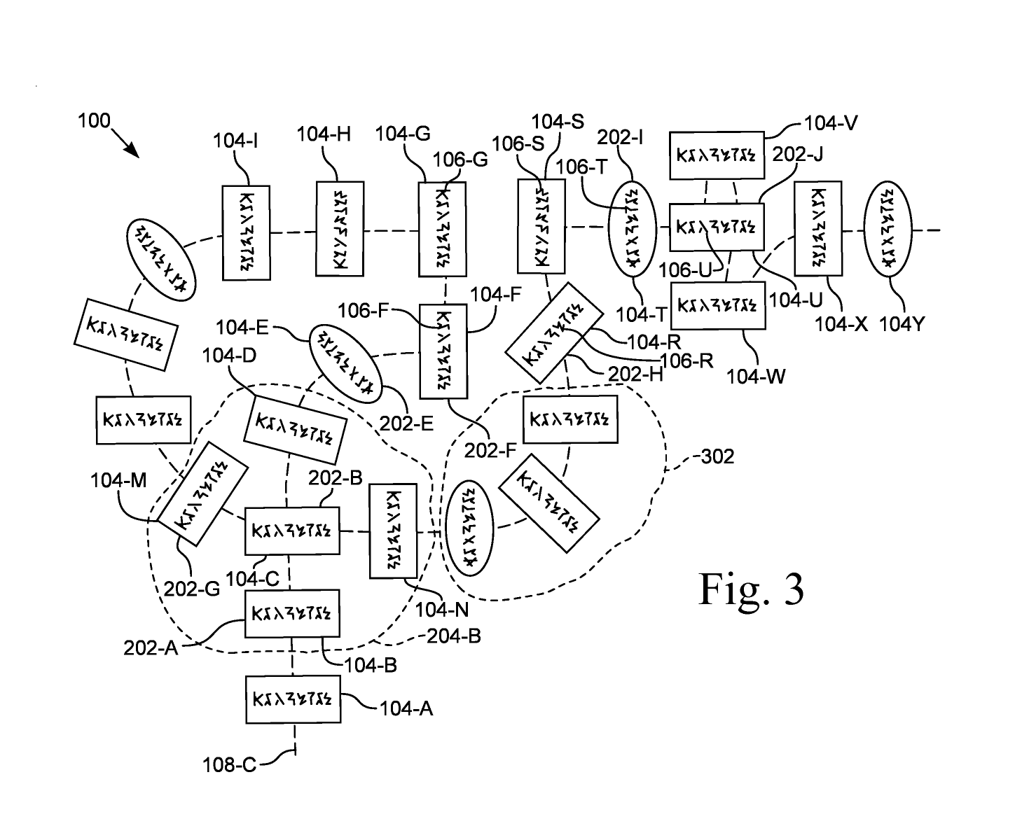

FIG. 3 illustrates a plan view of the educational aid 100 in FIG. 1 arranged into another navigable path 108-C with a complex configuration. The illustrated path 108-C teaches a different sequence than the paths 108-A, 108-B in FIG. 1 and FIG. 2. The path 108-C includes the baffles 202-A and 202-B from the path 108-B in FIG. 2. The path 108-C does not include baffles 202-C and 202-D from the path 108-B, however, baffles 202-E, 202-F, 202-G, 202-H, 202-I, and 202-J are added to path 108-C. The path 108-C also causes the student 102 to turn to the left and right instead of proceeding straight as with the paths 108-A and 108-B. The additional baffles 202-E, 202-F, 202-G, 202-H, 202-I, and 202-J and the path's 108-C deviation from a straight route cause the path 108-C to be more complex than either path 108-A or path 108-B.

The path 108-C begins in the same way as the path 108-B, starting with mat 104-A and including the baffles 202-A and 202-B. After the baffle 202-B, the path 108-C is curved. The curved segment includes the mat 104-E. The mat 104-E is a baffle 202-E. At the baffle 202-E, the student 102 must decide which one of four adjacent mats 104-F, 104-G, 104-H, 104-I is next in the path 108-C. The mat 104-F is next in the sequence if the path 108-C were to proceed straight. In the illustrated embodiment, the student 102 follows the curved segment to the mat 104-F.

The mat 104-F is a baffle 202-F. As with the baffle 202-E, there are four adjacent mats 104-R, 104-S, 104-G, 104-H that may be next in the path 108-C. In the illustrated embodiment, the next mat 104 in the path 108-C is to the left of the mat 104-F. Causing the student 102 to turn left makes this path 108-C more complex than the paths 108-A and 108-B, which do not deviate from the forward direction.

For the student 102 to more from the mat 104-G to the mat 104-M, the student 102 must only recall the recently traversed mat 104-E and follow the only other route available around a curved pattern. The mat 104-M is a baffle 202-G. The baffle 202-G is similar to the baffle 202-C in the path 108-B shown in FIG. 2. Each baffle 202-C, 202-G is part of an intersection 204. The intersection 204-B includes the baffle 202-G. The intersection 204-B is made up of the mats 104-B, 104-C, 104-D, 104-M, 104-N where only one of the mats 104-N has not been traversed.

The intersection 204-B introduces more complexity than the intersection 204-A even though they are both intersections 204. In FIG. 2, the baffle 202-C comes after a curved pattern including seven mats 104-D to 104-J, which follow a baffle 202-B. In FIG. 3, the baffle 202-G comes after two baffles 202-E, 202-F and a curved pattern including seven mats 104-G to 104-M, which follow a baffle 202-B. The additional baffles 202-E, 202-F in the path 108-C leading to the baffle 202-G in FIG. 3 increase the level of complexity over the level of complexity introduced by the baffle 202-C to the path 108-B in FIG. 2.

The increased level of complexity is due to the number of mats 104 and the number of baffles 202 encountered from the first pass through the intersection 204 and the second pass through the same intersection 204. As complication increases between encounters with an intersection 204, the likelihood of the student 102 forgetting what mats 104 were previously traversed increases. In this way, the second traversal becomes less intuitive, thus requiring knowledge of the sequence being taught.

The student 102 moves through the path segment 302. The path segment 302 is a simple curved segment of the path 108-C having no alternative route. The path segment 302 leads to the mat 104-R. The mat 104-R is a baffle 202-H. One of four mats 104-F, 104-G, 104-S, 104-T presents the next move along the path 108-C. The mats 104-F and 104-G have already been traversed so the complexity presented by the baffle 202-H is diminished. The complexity of the path 108-C leading to the second encounter with the mats 104-F, 104-G is a factor in the ease in which a student 102 disregards the mats 104-F, 104-G as being previously traversed. The most complex part of the decision to be made at the baffle 202-H is which of the two remaining mats 104-S, 104-T is next in the path 108-C. The student 102 who is knowledgeable about the sequence will know that the sequence indicia 106-R on the mat 104-R is followed by the sequence indicia 106-S on the mat 104-S.

When the student 102 reaches the mat 104-T, the student 102 must make a decision as to what is the next mat 104. The mat 104-T is a baffle 202-I. The baffle 202-I presents the student 102 with four mats 104-U, 104-V, 104-W, 104-X from which to choose the next move. There are three mats 104-U, 104-V, 104-W lined up perpendicular to the current direction of the path 108-C.

Where the student 102 has a reach sufficient to skip over one mat 104, as shown in the figure, the student must consider moving to one of the four mats 104-U, 104-V, 104-W, 104-X. For the path 108-C, the student moves to the mat 104-U, then up to the mat 104-V, and finally skips over the mat 104-U down to the mat 104-W. Once the student 102 reaches the mat 104-W, the next move, which is to the mat 104-X, will not be complex because the student 102 will have just traversed the other adjacent mats 104-U, 104-V.

If the reach of the student 102 were restricted to the mats 104-U, 104-V, 104-W that are immediately adjacent to the mat 104-T, the student 102 would have to move to either the mat 104-V to the left of the student 102 or the mat 104-W to the right of the student 102. Because the student 102 would not be able to step over the mat 104-U when moving along the path 108-C, the student 102 would move from one of the two mats 104-V, 104-W to the next mat 104-U, and so forth.

Another path 108 similar to path 108-C, but without the baffle 202-I, would be less complex than the path 108-C, but still more complex than the paths 108-A and 108-B. A path 108 is capable of being made incrementally more or less complex or equally complex at each progression through the teaching process by adding or removing baffles 202 as well as changing the orientation of the indicia 106, 114 or causing the student 102 to turn left or right when moving straight is an option.

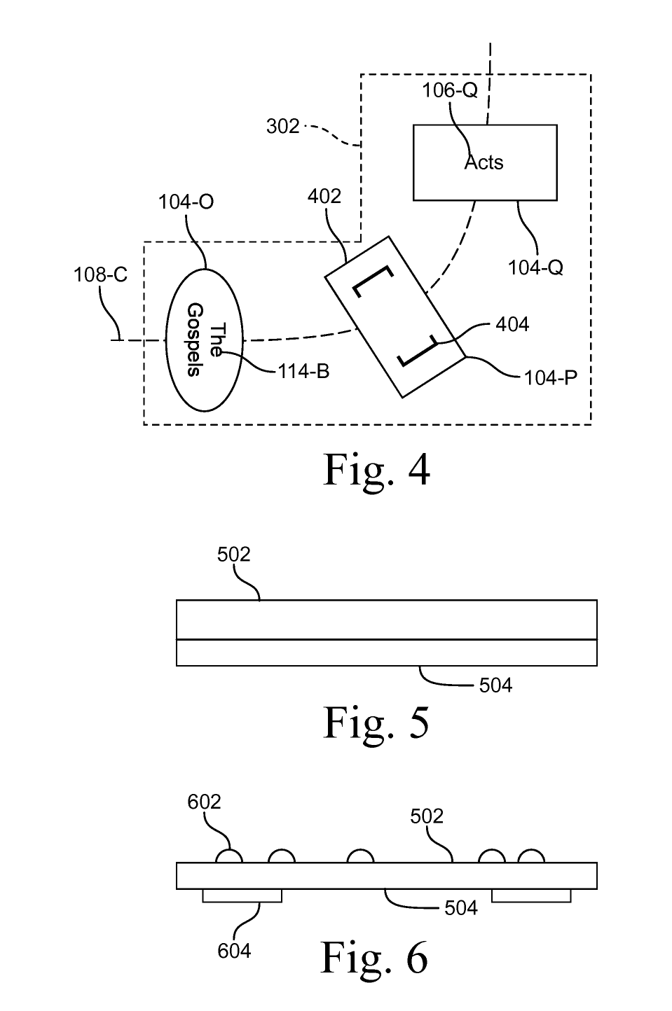

FIG. 4 illustrates a plan view of the path segment 302 in FIG. 3 with a test point 402. A student's 102 knowledge of a sequence, including groups and subgroups within a sequence, is tested by traversing a path 108. The student's 102 knowledge of the sequence is also tested by adding test points 402 to the series of mats 104 arranged in a navigable path 108 defining the sequence. A test point is a gap in the sequence of named objects. The difficulty of a test point 402 varies by the member or group within the sequence being tested as well as the number of members being tested at a test point 402. The test points 402 are inserted into the path 108 as mats 104 bearing test indicia 404 to replace either one or more members, a group, or a subgroup of a sequence. The student 102, upon reaching a test point 402, is to provide a response in which the missing sequence information is given.

While traversing the path segment 302, the student 102 steps from the mat 104-O bearing the group indicia 114-B that identifies a group name, The Gospels, and the subdivision characteristic, an oval shape. The group name, The Gospels, is a subdivision of the Holy Bible. The path 108-C in the path segment 302 is not challenging to the student 102 because the next mat 104-P is apparent from its location relative to the previous mat 104-O. The complexity of the path 108-C in the path segment 302 is in the test point 402. In the illustrated embodiment, the test indicia 404 are brackets. The brackets indicate that one or more members are missing from the sequence. The student 102 uses the group indicia, The Gospels, 114-B on the previous mat 104-O and the sequence indicia, Acts, 106-Q on the following mat 104-Q to recite the names of the missing members of the sequence. The knowledgeable student 102 knows to recite the books of the Holy Bible contained in the group name, The Gospels, at the illustrated test point because the sequence member, Acts, follows the members of the group, The Gospels, in the sequence being taught and the mat 104-Q following the test point 402 bears the sequence indicia, Acts, 106-Q.

In the illustrated embodiment, the test point 402 includes test indicia 404 directing the student 102 to respond by identifying the missing members of the sequence. In various embodiments, the test point 402 bears test indicia 404 prompting the name of the group, subgroup, or the name of a single member of the sequence or the test point 402 is blank or the test point 402 is absent. In still other embodiments, a mat 104 is out of sequential order. In each case, the student 102 is to notice that the student 102 is being tested and respond accordingly.

FIG. 5 illustrates a side view of one embodiment of a mat 104. The mat 104 is an object that displays information about a sequence. In the illustrated embodiment, the mat 104 includes a top surface 502 and a bottom surface 504. In one such embodiment, the top surface 502 bears sequence indicia 106, group indicia 114, and/or test indicia 404. In other embodiments, the indicia 106, 114, 404 is displayed below and is visible through the top surface 502. The top surface 502 is read by the student 102 to gain information about a sequence.

Where the student 102 steps onto the top surface 502, the top surface 502 is slip resistant to the soles of shoes or feet. The bottom surface 504 is configured such that the interface between the bottom surface 504 and the surface on which it is placed resists slipping. The mat 104 is thin to reduce the risk of a student 102 tripping on the mats 104. In one embodiment, the top surface 502 is carpet pile and the bottom surface 504 is a non-skid surface, for example, a vinyl or latex coating, or the bottom surface 504 is rubber.

FIG. 6 illustrates a side view of another embodiment of a mat 104′. The mat 104′ is attached to a training surface by an attachment device 604. The attachment device 604 provides a detachable connection to a training surface such that the mats 104 remain substantially stationary when a student 102 contacts the mats 104 during use. The bottom surface 504 is configured to receive an attachment device 604. In various embodiments, the attachment device 604 is a magnet or part of a hook and loop system or an adhesive strip or other material or system for removable attachment of a mat 104 to a training surface. Where the student 102 is blind, the mats 104′ are arranged in a navigable path 108 on a training surface such as a table for navigation by hand. The indicia 106, 114, 404 are located on the top surface 502 as raised bumps 602 configured in braille for reading by touch. The student 102 moves a hand along the path 108 from one mat 104 to the next mat 104 according to the sequence.

Teaching a sequence to a student 102 includes presenting the sequence to the student 102 as a navigable path 108 that is changeable such that traversal of the path 108 is made progressively more difficult as the student 102 becomes familiar with the sequence. The path 108-A in FIG. 1 represents an initial arrangement of mats 104 for teaching a sequence to a student 102 who is beginning to learn the sequence.

The student 102 learns the sequence by viewing the sequence information presented by each mat 104 while traversing the path 108-A. The student 102 repeatedly traverses the path 108-A by moving from one mat 104 to another mat 104 according to the sequence. In one embodiment, the student 102 traverses the path 108-A as auditory clues are provided. Auditory clues include recitation of the names of the members of the sequence by an instructor as the student 102 advances from one mat 104 to the next mat 104 or a recorded recitation of the names of each of the members of the sequence such that the student 102 keeps pace with the recitation. In another embodiment, the student 102 recites the names of the members of the sequence as the student 102 traverses the path 108-A.

The collection of mats 104 is configured to present paths 108 progressively more complex by changing the configuration of the path 108, adding baffles 202 to the path 108, and/or by changing the orientation of the sequence and group indicia 106, 114. One series of progressively more complex configurations is represented by the paths 108-A shown in FIG. 1, 108-B shown in FIG. 2, and 108-C shown in FIG. 3, each figure being increasingly more complex.

By constructing progressively more complex paths 104, the student 102 continues to be challenged, but is not discouraged by significant changes in the level of complexity. By making incremental changes to the complexity of the path 108, the student 102 more quickly traverses a modified path 108 correctly. Testing incrementally motivates the student 102 to learn the sequence.

A path 108 that turns left or right at a baffle 202 is more complex than a path 108 that passes from the baffle 202 to a mat 104 located directly in front of the baffle 202. Causing the student 102 to change directions at a baffle 202 is one way the educational aid 100 produces incrementally more complex paths 108 as the student 102 learns the sequence.

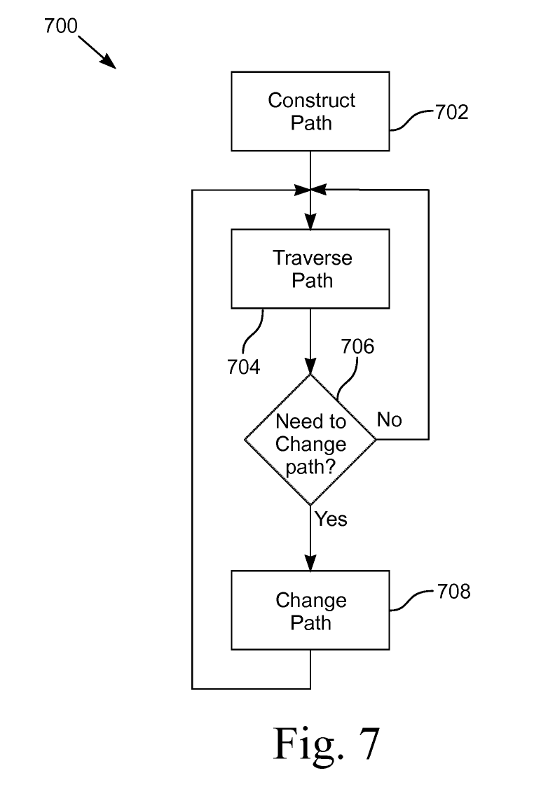

FIG. 7 illustrates a flow diagram of one embodiment of a teaching method 700 using an educational aid 100 to teach a sequence to a student 102. The first step 702 is to construct a navigable path 108. The mats 104 are arranged in sequential order to form a path 108. The path 108 is constructed to present a level of complexity according to the student's 102 knowledge of the sequence. Depending on the knowledge of the student 102, the path 108 is capable of being made incrementally more or less complex by adding or removing baffles 202.

In another embodiment, the complexity of the path 108 is increased by changing the orientation of the sequence indicia 106 and/or the group indicia 114 relative to the direction of the path 108 and/or relative to each other. That is, when the student 102 is presented with a baffle 202 where a choice must be made as to which is the next mat 104 in the sequence, the orientation of the sequence indicia 106 and/or group indicia 114 is such that the orientation does not provide a clue. For example, if the orientation of the indicia 106, 114 for the next mat 104 is the only mat 104 with indicia 106, 114 oriented consistent with the direction of the path 108, then the path 108 becomes apparent and can be traversed with limited knowledge of the sequence. But, if the indicia 106, 114 on each mat 104 is oriented in the same direction, for example, facing North, then the path 108 is not indicated by the orientation of the indicia 106, 114.

Where the student 102 has no knowledge of the sequence, the path 108 is made simple and easy to follow. For example, the navigable path 108-A in FIG. 1 presents the sequence such that following the path 108-A from the entrance mat 104-A to the exit mat 104-Y requires no knowledge of the sequence. Where the student 102 is very knowledgeable about the sequence, a complex path 108 is constructed, such as the path 108-C shown in FIG. 3.

The next step 704 is traversal of the path 108. When the student 102 traverses the path 108 the student's 102 knowledge of the sequence is increased and/or tested. Traversing of the path 108 includes moving over each mat 104 according to the sequence presented by the path 108. At each test point 402, the student 102 is to respond by filling in the missing sequence information. In one embodiment, the student 102 recites the part of the sequence represented by the sequence indicia 106, group indicia 114, and test indicia 404 on each mat 104 as it is reached. In another embodiment, the student 102 receives auditory clues to guide the student 102 along the path 108. For example, an instructor speaks the names of the members and/or groups of the sequence as the student 102 approaches each mat 104. In another example, a recording audibly announces the names of the members and/or groups of the sequence and the student 102 follows the path 108 so as to approach each mat 104 as its indicated name is announced. In yet another embodiment, when the student 102 reaches a test point 402 where a member or a group of the sequence is missing, the student 102 recites the names of the missing members.

The next step 706 is deciding whether to change the path 108. The decision to change the path 108 is based on several considerations, such as the length of time or number of times that the student 102 has traversed the same configuration of mats 104, the student's 102 level of interest in traversing the path 108 or attention given during the traversal of the path 108, and the progress the student 102 makes while repeatedly traversing the path 108. Changing the path 108 maintains the student's 102 interest in the learning process. Where the changes produce a progressively more complicated path 108, the student 102 is motivated upon each successful traversal.

Deciding whether to change the path 108 requires monitoring the student's 102 progress along the path 108 to understand the student's 102 familiarity with the path 108 and the sequence being taught. For example, if the student 102 is unable to correctly respond at the test point 402 or is focused on the path 108 instead of relying on the sequence indicia 106 and/or group indicia 114 to follow the sequence, the student 102 is not ready for a more challenging path 108. Conversely, if the student 102 correctly responds at the test point 402 and readily follows the sequence with only inconsequential reference to the sequence indicia 106 and/or group indicia 114, the student 102 is prepared to attempt a more complex path 108. If the path 108 is to be changed, the next step 708 applies. Otherwise, repeat the step 704.

The next step 708 is to change the path 108. The path 108 is changed such that it is more or less complex. Where the student 102 has difficulty traversing the path 108, the path 108 is made less complex by removing baffles 202 and/or test points 402. Conversely, where the student 102 traverses the path 108 with ease, the path 108 is made more complex. Changing the path includes changing the configuration of the path 108, increasing or decreasing the number of baffles 202 in the path 108, increasing or decreasing the number of test points 402 in the path 108, and/or changing the orientation of the sequence indicia 106 and/or group indicia 114.

Changing the configuration of the path 108 includes rearrangement of the mats 104 or having the student 102 traverse the path 108 in reverse order, or in the opposite direction from the exit mat 104-Y to the entrance mat 104-A. Increasing or decreasing the number of baffles 202 introduce varying levels of complexity to the path 108. Baffles 202 cause the student 102 to consider alternative routes while traversing the path 108. Changes such as these maintain the interest of the student 102 because each variation in the activity challenges the student 102 to traverse a different path 108. Where the path 108 is to be made less complex, baffles 202 are made less complex or baffles 202 are removed from the path 108. Conversely, where the path 108 is to be made more complex, baffles 202 are made more complex or baffles 202 are added to the path 108.

Increasing or decreasing the number of test points 402 in the path 108 is another way to make the path 108 more or less complex. Test points 402 are added or removed from the path 108 according to the desired difficulty level. Some members of a sequence are more difficult to know than others. Some test points 402 replace more members of a sequence than others. Accordingly, varying levels of difficulty are achieved by increasing or decreasing the number of test points 402.

Changing the orientation of the sequence indicia 106 and group indicia 114 challenges the student 102 as to the direction of the path 108. Students 102 not only look at a segment of the path 108 to determine the correct direction, but students 102 look at the orientation of the indicia 106, 114 on the path 108. Where the indicia 106, 114 is text, the student 102 who does not know the sequence may follow a route with the indicia 106, 114 oriented upright for reading even though the chosen route is not the path 108.

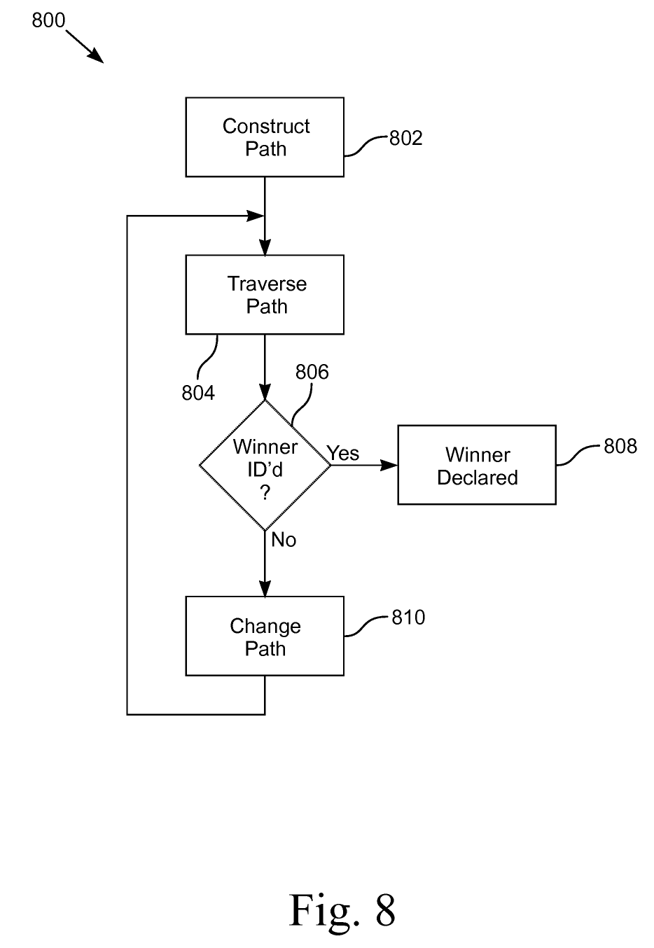

FIG. 8 illustrates a flow diagram of one embodiment of a competitive game 800 using an educational aid 100 to teach a sequence to group of students 102. The first step 802 is to construct a navigable path 108. The mats 104 are arranged in a sequential order to form a path 108. The path 108 is constructed to present a level of complexity according to the students' 102 knowledge of the sequence. Where the students 102 have no knowledge of the sequence, the path 108 is simple and easy to follow. For example, the navigable path 108-A in FIG. 1 presents the sequence such that following the path 108-A requires no knowledge of the sequence.

The next step 804 is to traverse the path 108. A student 102 traverses the path 108 until the student 102 reaches the end of the path 108 or fails to correctly follow the path 108 or responds incorrectly at a test point 402. When a student 102 fails to reach the end of the path 108, that student 102 is out of the competitive game 800. In the traversing step 804 several students 102 traverse the path 108 one at a time until all of the students 102 have either reached the end of the path 108 or are out of the game 800.

The next step 806 is to determine if there is a winner. If only one student 102 has successfully traversed the path 108, that student 102 is identified as the winner. When a winner is identified, the next step 808 is to declare a winner. If there is more than one student 102 remaining, the next step 810 is to change the path 108. If there are no students 102 who successfully traverse the path 108 in step 804, then those students 102 who attempted to traverse the path 108 in the last traversal repeat step 804.

If there is one student remaining, step 806 identifies that student 102 as the winner and the next step 808 is to declare a winner of the game 800. The winner is the student 102 identified as the winner in step 806. The game 800 ends when a winner is declared.

If there is no winner declared, the next step 810 is to change the path 108. The path 108 is changed to be more complex. In that way, the student's 102 knowledge is further tested. Changing the path 108 includes changing the configuration of the path 108, adding baffles 202 of varying complexity, adding a test point 402 and/or changing the orientation of the sequence indicia 106 and/or group indicia 114. When step 810 is completed, repeat step 804.

The educational aid 100 includes various functions. The function of teaching a sequence, including groups and subgroups within the sequence, to a student 102 is implemented, in one embodiment, by a navigable path 108 over which the student 102 navigates. The navigable path 108 presents the sequence in various configurations to challenge the student 102 to learn the sequence.

The function of testing a student's 102 knowledge of a sequence, including groups and subgroups within the sequence, is implemented, in one embodiment, by a navigable path 108. The navigable path 108 presents the sequence such that the student 102 is tested on his knowledge of the sequence. The function of testing a student's 102 knowledge of a sequence, including groups and subgroups within the sequence, is implemented, in another embodiment, by a test point 402. The test point 402 prompts the student 102 to recite a missing member of the sequence or a missing group of members thereof while traversing the path 108 that presents the sequence.

The function of identifying a group within a sequence is implemented, in one embodiment, by a mat 104. The mat 104 indicates a group of members within a sequence by preceding or following the group within a path 108 and bearing group indicia 114 that names the group and/or being a specified texture, shape, size, and/or color.

The function of identifying a group with a sequence is implemented, in one embodiment, by a group indicia 114. The group indicia 114 identifies a member of a group by appearing on a mat 104 that bears a corresponding sequence indicia 106 such that the represented member of the sequence is associated with a specified group within the sequence. Characteristics of the group indicia 114 include color, texture, font, and/or shape.

The function of causing a student 102 to be physically active while learning a sequence, including groups and subgroups within the sequence, is implemented, in one embodiment, by a navigable path 108. The navigable path 108 is presented on a training surface such that the student 102 physically moves through the navigable path 108.

The function of teaching a sequence, including groups and subgroups within the sequence, to a blind student 102, is implemented, on one embodiment, by a navigable path 108 made up of a series of mats 108. The mats 108 bear indicia 106, 114, 404 in braille format, such that the student 102 traverses the path 108 by hand.

From the foregoing description, it will be recognized by those skilled in the art that an educational aid 100 for teaching a sequence, including a sequence having groups and subgroups within the sequence, to a student 102 has been provided. The educational aid 100 presents the sequence to be taught as a navigable path 108 in such a way that the student 102 learns the sequence as well as any groups and subgroups of the sequence that are being taught. The navigable path 108 is changeable to make traversal progressively more difficult. The navigable path 108 is used to play a competitive game 800 where the students 102 are challenged to learn the sequence.

The navigable path 108, in one embodiment, includes mats 104 with sequence indicia 106. The mats 104, in one embodiment, are placed on a walking surface. In this way, the student 102 is physically active while traversing the path 108. The path 108 is determined by the order in which the mats 104 are laid out. Navigation of the path 108 requires that the student 102 follow the sequence indicia 106 on the mats 104 such that the mats 104 are passed over in the order of the sequence being taught.

The mats 104 present information about the sequence through sequence indicia 106 and/or group indicia 114 on the mat 104 as well as the shape, color, texture, and size of the mat 104. These variations as well as the changeable path 104 increase the motivation of the student 102 to learn to the sequence. A test point 402 provides another motivation to the student 102 by testing the student's 102 knowledge of the sequence in a progressively more difficult way so that in the early learning stages, the student 102 is attentive and motivated.

In one embodiment, the mats 104 are arranged in a path 108 on a training surface such as a table for navigation by hand. In one embodiment, the mats 104 include indicia 106 written in braille. In this way, a blind student 102 follows the path 108 by touching the mats 104. In one embodiment, the mats 104 include a magnet 604 for attaching the mat 104 to a metal surface.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for an educational aid to teach a sequence to a student, said apparatus comprising:
a path defined by a plurality of first indicia having an order, said plurality of first indicia representing a plurality of named objects in said order, said path having a direction from an entrance to an exit, said path changeable from a first configuration to a second configuration,
said first configuration being a simple configuration, wherein for each one of said plurality of first indicia before a last one of said plurality of first indicia, a next one of said plurality of first indicia in said direction is apparent because only said next one of said plurality of first indicia is adjacent to said each one of said plurality of first indicia,
said second configuration being a first complex configuration, whereby the student is presented with a progressively more complex configuration of said path as the student learns said order of said plurality of named objects.

2. The apparatus of claim 1 wherein said first complex configuration includes a baffle.

3. The apparatus of claim 2 wherein said baffle is one of said plurality of first indicia that is adjacent to more than two others of said plurality of first indicia, said next one of said plurality of first indicia being near said one of said plurality of first indicia.

4. The apparatus of claim 1 further including a third configuration of said path, said third configuration being a second complex configuration that has a greater complexity than said first complex configuration.

5. The apparatus of claim 4 wherein said first complex configuration includes a first number of baffles, said second complex configuration includes a second number of baffles, said second number of baffles being greater than said first number of baffles.

6. The apparatus of claim 1 wherein said path is dimensioned to be traversed by the student moving along said path, with each one of said plurality of first indicia separated by a distance approximating a single step of the student.

7. The apparatus of claim 1 wherein said path is disposed on a surface, said each one of said plurality of first indicia providing a tactile indication.

8. The apparatus of claim 1 further including at least one second indicia representing a group of said plurality of named objects, each one of said at least one second indicia associated with a corresponding one of said plurality of first indicia.

9. The apparatus of claim 1 further including at least one test point, said at least one test point representing a gap in said plurality of named objects.

10. An apparatus for an educational aid to teach a sequence to a student, said apparatus comprising:
a plurality of carriers, said plurality of carriers being dimensioned and configured to form a path, said path having a plurality of configurations;
a plurality of first indicia, each one of said plurality of first indicia representing a member of a set of named objects, said each one of said plurality of first indicia associated with one of said plurality of carriers; and
a set of instructions including:
a) an instruction to arrange more than two of said plurality of carriers into a first one of said plurality of configurations,
b) an instruction directing the student to navigate said first one of said plurality of configurations at least once,
c) an instruction to arrange said more than two of said plurality of carriers into a second one of said plurality of configurations such that said second one of said plurality of configurations requires more knowledge of the sequence for the student to navigate than said first one of said plurality of configurations, and
d) an instruction directing the student to navigate said second one of said plurality of configurations at least once.

11. The apparatus of claim 10 wherein said set of instructions further includes e) an instruction to arrange said more than two of said plurality of carriers into a third one of said plurality of configurations such that said third one of said plurality of configurations requires more knowledge of the sequence for the student to navigate than said second one of said plurality of configurations and f) an instruction directing the student to navigate said third one of said plurality of configurations at least once.

12. The apparatus of claim 11 wherein said set of instructions further includes g) an instruction to arrange said more than two of said plurality of carriers into a selected number of increasingly more complex configurations and h) an instruction directing the student to navigate each one of said selected number of increasingly more complex configurations at least once.

13. A method of teaching a sequence to a student comprising the steps of:
a) making a path defined by a plurality of first indicia having an order, said plurality of first indicia representing a plurality of named objects in said order, said path having a direction from an entrance to an exit, said path having a first level of complexity;
b) traversing said path having said first level of complexity at least once;
c) changing said path to have an increased level of complexity, said increased level of complexity being achieved by adding at least one baffle to said path, each one of said at least one baffle being one of said plurality of first indicia that is adjacent to more than two other of said plurality of first indicia, a next one of said plurality of first indicia being near said each one of said at least one baffle;
d) traversing said path with said increased level of complexity at least once; and
e) repeating steps c) and d) a selected number of times.

14. The method of claim 13 further including, between steps c) and d), the step of adding a test point to said path, said test point representing at least one missing object of said plurality of named objects.

15. The method of claim 14 further including the step of requesting that said at least one missing object of said plurality of named objects be identified.

16. The method of claim 13 wherein each of said steps b) and d) of traversing said path includes the step of tactilely detecting said plurality of first indicia to traverse said path.

17. The method of claim 13 wherein said path is dimensioned to be traversed by the student moving along said path, with each one of said plurality of first indicia separated by a distance approximating a single step of the student, wherein each of said steps b) and d) of traversing said path includes the student moving along said path.

18. The method of claim 13 wherein each of said steps a) of making said path and c) of changing said path includes the step of adding at least one second indicia representing a group of said plurality of named objects, each one of said at least one second indicia associated with a corresponding one of said plurality of first indicia.

19. The method of claim 13 wherein said step b) of traversing said path includes receiving guidance in traversing said path.

20. The method of claim 13 wherein a plurality of students perform steps b) and d) of traversing said path where step d) further includes step d1) eliminating each one of said plurality of students who is unsuccessful in traversing said path and step d2) determining a winner when only one of said plurality of students remains.
